(19) United States
(12) Patent Application Publication
(10) Pub. No.: US 2012/0297345 A1
(43) Pub. Date: Nov. 22, 2012

(54) Three-Dimensional Animation for Providing Access to Applications

(75) Inventor: Laurent Baumann, Campbell, CA (US)

(73) Assignee: APPLE INC., Cupertino, CA (US)

(21) Appl. No.: 13/111,923

(22) Filed: May 19, 2011

(51) Int. Cl. G06F 3/048

(52) U.S. Cl. 715/848

(57) ABSTRACT

A three-dimensional animation for providing access to applications is described. In some implementations, a three-dimensional multi-level dock is displayed. The multi-level dock can be animated to appear to slide into view on a graphical user interface in response to user input. The levels of the multi-level dock can be configured to display selectable graphical objects representing applications available on a computing device. A user can select a graphical object to invoke a corresponding application. The three-dimensional multi-level dock can be animated to slide out of view on the graphical user interface in response to the selection of an application object or in response to other user input.

### TECHNICAL FIELD

The disclosure generally relates to graphical user interfaces for accessing applications.

### BACKGROUND

Computing devices often have many software applications available to users. A user of a computing device can invoke applications in a variety of ways. Names of applications available on a computing device can be presented as a textual list and a user can select a name in the list to invoke an application. Selectable icons representing available applications can be displayed on user interfaces of the computing device and a user can select an icon to invoke an application on the computing device. Users sometimes have to navigate through several layers of menus or other interfaces to access applications on a computing device which is often inefficient and inconvenient.

### SUMMARY

A three-dimensional animation for providing access to applications is described. In some implementations, a three-dimensional multi-level dock is displayed. The multi-level dock can be animated to appear to slide into view on a graphical user interface in response to user input. The levels of the multi-level dock can be configured to display selectable graphical objects representing applications available on a computing device. A user can select a graphical object to invoke a corresponding application. The three-dimensional multi-level dock can be animated to slide out of view on the graphical user interface in response to the selection of an application object or in response to other user input.

Particular implementations provide at least the following advantages: the animation provides an easier and more convenient way for users to access applications on a computing device.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an example interface of a computing device.

FIG. 2 illustrates an example three-dimensional animation for providing access to applications on the computing device.

FIG. 3 illustrates an example options interface for the three-dimensional animation.

FIG. 4 is flow diagram of an example process for presenting the three-dimensional animation for providing access to applications.

FIG. 5 is a block diagram of an example system architecture implementing the features and processes of FIGS. 1-4.

Like reference symbols in the various drawings indicate like elements.

### DETAILED DESCRIPTION

### Example Interface

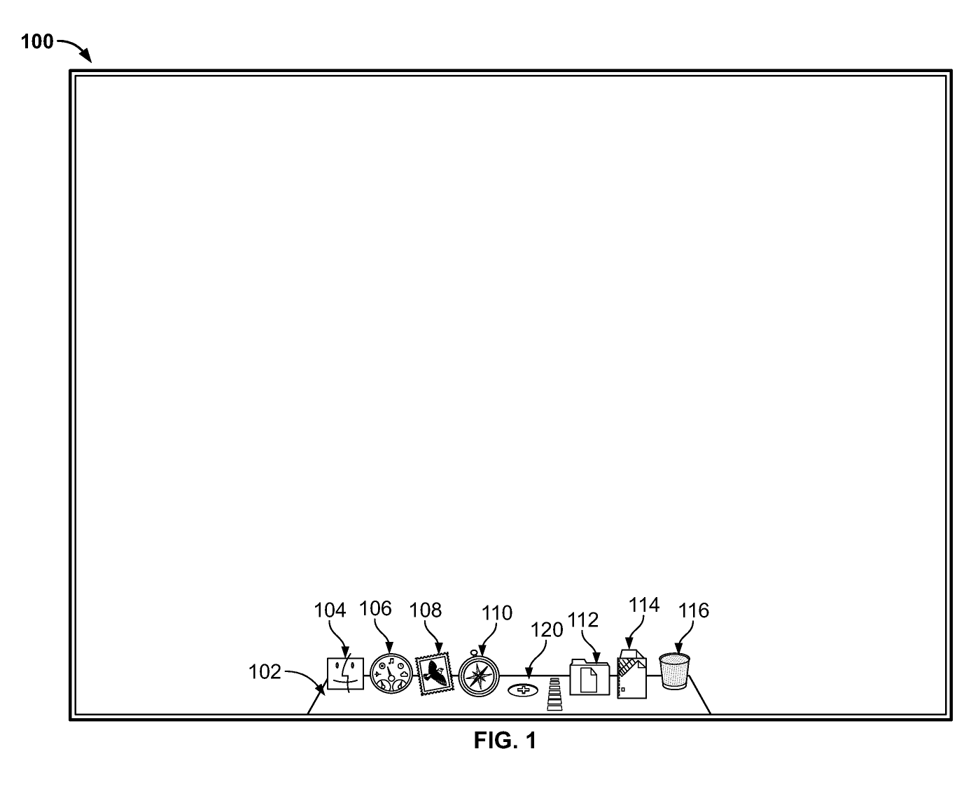

FIG. 1 illustrates an example interface 100 of a computing device. In some implementations, interface 100 includes a dock 102 for displaying display objects 104-116. Display objects 104-116 can be selected to invoke operations on the computing device. For example, display object 110 can be selected and in response to the selection an application (e.g., a browser application, mail application, etc.) on the computing device can be invoked. Display object 112 can be selected and in response to the selection a window representing a directory or file on the computing device can be displayed.

In some implementations, the display objects 104-116 displayed in dock 102 can represent a subset of all of the applications and/or files available on the computing device. For example, display objects 104-116 can represent a user selected group of applications available on the computing device. The display objects 104-116 can represent the most frequently used display objects, applications, directories and/or files on the computing device. In some implementations, dock 102 can be configured to appear at the bottom edge of interface 100, as illustrated by FIG. 1. In some implementations, dock 102 can be configured to appear at the left edge, right edge, or top edge of interface 100. Thus, dock 102 can be oriented horizontally or vertically on interface 100.

Dock 102 and display objects 104-116 can provide easy and convenient access to applications and files available on the computing device. However, the space available or provided by dock 102 for presenting display objects is limited. Only a small number of display objects can be presented on dock 102. Thus, if there are many applications installed or stored on the computing device, a user will not be able to access all of the applications through dock 102.

In some implementations, dock 102 can include a selectable graphical element 120 for invoking an animation for providing access to applications and/or files available on the computing device. For example, a user can select graphical element 120 to cause a multi-level dock animation to display on the computing device. In some implementations, the multi-level dock animation can be configured to display objects representing applications available on the computing device. In some implementations, the multi-level dock animation can be configured to display objects representing files (e.g., folders, directories, media files, text documents, etc.) available on the computing device.

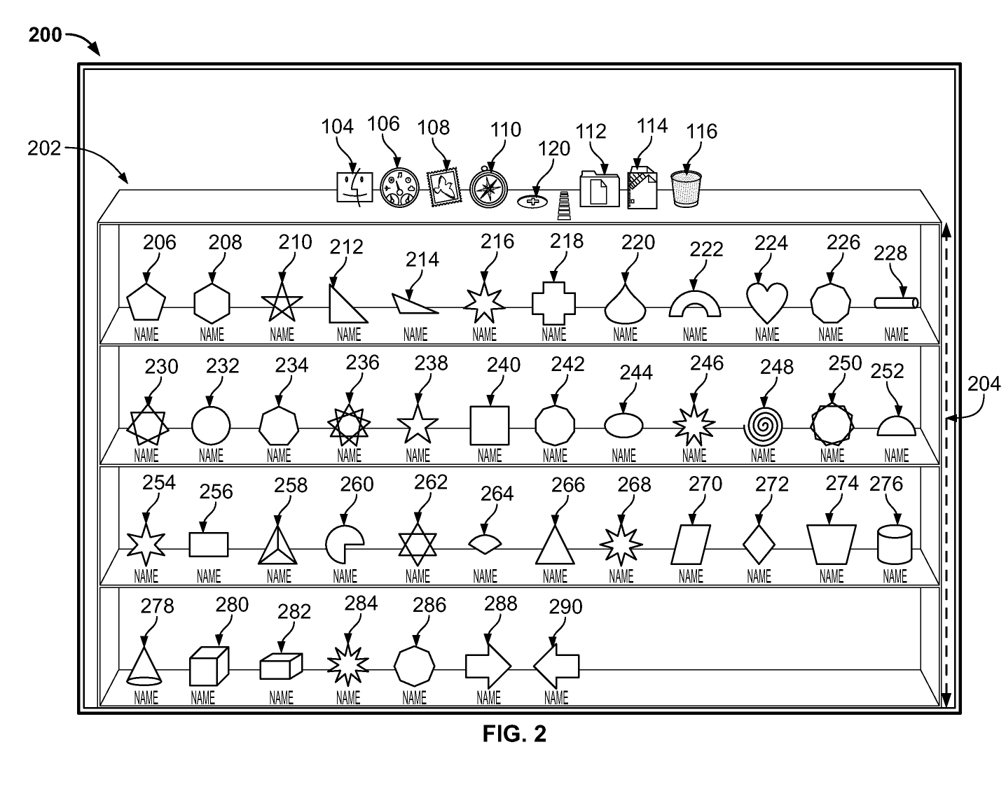

FIG. 2 illustrates an example interface 200 having a three-dimensional animation 202 for providing access to applications on a computing device. In some implementations three-dimensional animation 202 can appear as a multi-level dock that slides into view on interface 200. For example, multi-level dock 202 can slide into view on interface 200 by appearing to rise up from the bottom edge of interface 200, as represented by dashed line 204. In some implementations, dock 102 can appear to transform into the top level of the multi-level dock animation. For example, dock 102 can be expanded to become part of the multi-level dock. In some implementations, multi-level dock 202 can slide into view from the left edge, right edge, or top edge of interface 200. For example, multi-level dock 202 can slide into view toward the middle of interface 100 from any edge of interface 200 according to the orientation of dock 102 on interface 100. In some implementations, the edge from which the multi-level dock 202 appears can correspond to an edge of interface 202 where dock 102 is presented.

In some implementations, display objects 104-116 and graphical element 120 can appear on the top level of multi-level dock 202. For example, when a user selects graphical element 120 on dock 102, the multi-level dock animation 202 can be invoked. When multi-level dock animation 202 is invoked, dock 102 can be expanded to become the top level of multi-level dock animation 202. For example, when dock 102 is displayed horizontally at the top or bottom edge of interface 100 and the multi-level dock animation 202 is invoked, the width of dock 102 can be increased to the width of the multi-level dock animation 202. In some implementations, the width of the multi-level dock animation 202 can be substantially the width (or height, depending on the orientation of dock 102) of interface 100. In some implementations, the display objects 104-116 displayed on dock 102 appear to remain in place as dock 102 is expanded. For example, as dock 102 is expanded to become the top level of multi-level dock 202, display objects 104-116 remain in place on the expanded dock and are presented on the top level of multi-level dock 202.

In some implementations, multi-level dock 202 can contain levels that present display objects representing applications and/or files available on the computing device. In some implementation, multi-level dock animation 202 can dynamically determine a number of display objects to display in the multi-level dock and determine a number of levels required to display the determined number of display objects. For example, multi-level dock animation 202 can determine the number of applications available on the computing device and determine a number of display objects based on the number of applications. Multi-level dock animation 202 can determine a width of multi-level dock 202, and a width of each level of multi-level dock 202, based on the dimensions of interface 200. For example, the width of each level can correspond to substantially the width (or height, depending on the orientation of dock 102) of interface 200. Based on a size of each display object and the width of each level, multi-level dock 202 can determine the number of levels required to present display objects for each application available on the computing device. Thus, multi-level dock 202 can provide a single graphical user interface for presenting and accessing all of the applications available on the computing device.

In some implementations, a user of the computing device can select a display object presented on multi-level dock 202. For example, a user can invoke multi-level dock 202 by selecting graphical element 120. Multi-level dock 202 can be animated to slide into view on interface 200, as described above. Each level of multi-level dock 202 can present display objects corresponding to the applications and/or files available on the computing device. A user can select a display object presented in multi-level dock 202 to invoke an application and/or display a file corresponding to the selected display object.

In some implementations, in response to a selection of a display object, multi-level dock 202 can be animated to slide out of view on interface 200. In some implementations, multi-level dock 202 can be animated to slide out of view in response to a selection of graphical element 120. For example, multi-level dock 202 can be animated to gradually disappear into an edge of interface 200 from which multi-level dock 202 originally appeared, as illustrated by dashed line 204. In some implementations, as multi-level dock 202 is removed from interface 202, the top level of multi-level dock 202 can be converted back to dock 102. For example, once multi-level dock 202 has been lowered into the bottom edge of interface 200, the top level of multi-level dock 202 that presents display objects 104-116 can be modified, or morphed, back into the shape of dock 102 and display objects 104-116 can be presented on dock 102.

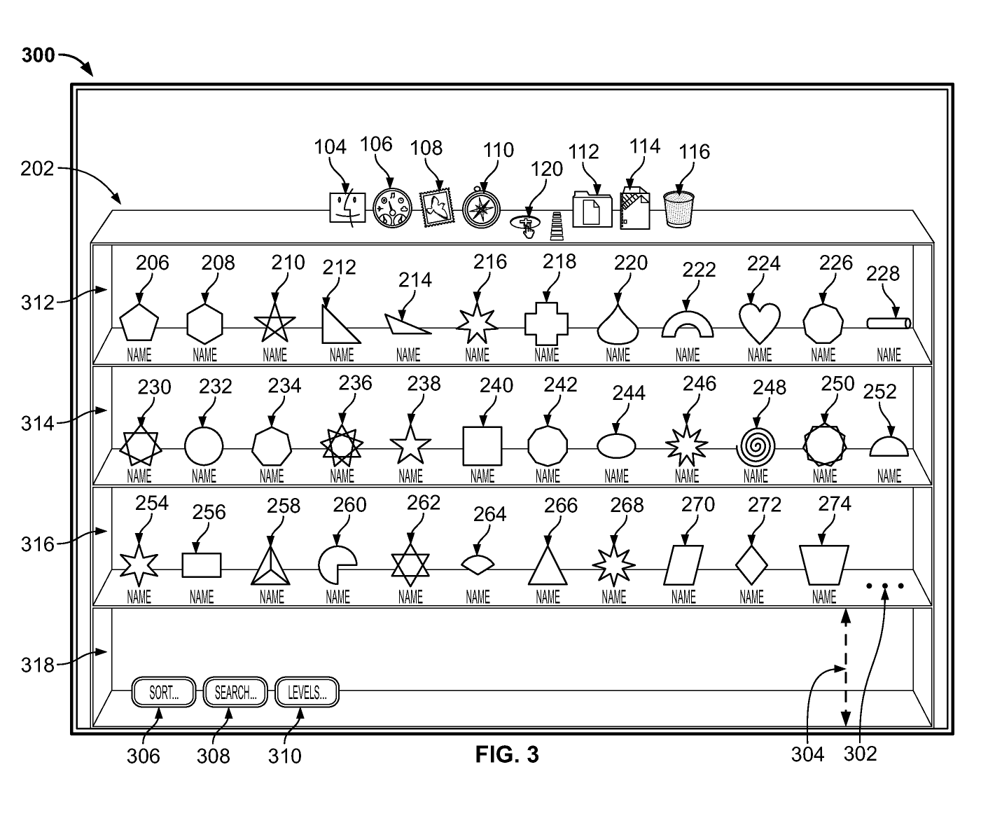

FIG. 3 illustrates an example options interface for the three-dimensional animation. In some implementations, graphical element 302 can be selected to display an options interface for multi-level dock 202. For example, multi-level dock 202 can be configured to initially present levels 290, 292 and 294. A user can select graphical element 302 to display level 312. For example, upon selection of graphical element 302, multi-level dock 202 can be animated to display level 318 by sliding the multi-level dock upward (or sideways, according to the orientation of the multi-level dock) in user interface 300, as illustrated by dashed line 304.

In some implementations, level 312 can display graphical elements 306, 308 and/or 310 for specifying options for multi-level dock 202. In some implementations, a user can select graphical element 306 to specify options for sorting display objects 204-272. For example, selection of graphical element 306 can invoke an interface (not shown) for specifying options for sorting display objects 204-272. Display objects can be sorted by name. For example, each display object 204-272 can be associated with a name of an application or file corresponding to each object. For example, files can be displayed in top-down, left-to-right alphabetical order in multi-level dock 202. Objects can be sorted alphabetically or reverse alphabetically by name. Display objects can be sorted by frequency of use. For example, usage statistics can be collected on display objects, corresponding applications and/or corresponding files and display objects can be sorted based on the collected usage statistics. For example, the most frequently or most recently used display objects, applications and files can be displayed in top-down left-to-right order in multi-level dock 202.

In some implementations, a user can manually sort or arrange the display objects presented in multi-level dock 202. For example, a user can select, drag and drop display objects into positions in multi-level dock 202. A user can select display object 270, for example, and drag it to a position in level 312. Other display objects in level 312 and/or in the other levels 314, 316 of multi-level dock 202 can be adjusted to make room for the moved display object 270. For example, display objects can be moved in a level or moved to a new level to make room for the moved display object 270. In some implementations, a display object can be moved to and from the top level of the multi-level dock to add/remove display objects from dock 102.

In some implementations, a user can select graphical element 308 to search for display objects, applications and/or files available on the computing device. For example, some computing device can have large numbers of applications and/or files such that multi-level dock 202 may not have enough space for presenting display objects for every application or file on the computing. Graphical element 308 can be selected and a user interface presented that allows a user to search (e.g., by keyword, name, etc.) for applications and/or files available on a computing device. In some implementations, graphical element 308 can be selected to present a graphical user interface that allows a user to perform a search amongst the display objects presented in multi-level dock 202. For example, if a large number of display objects are presented in multi-level dock 202, a user can search (e.g., by name, keyword, category, etc.) for a particular display object in multi-level dock 202.

In some implementations, a user can select graphical element 310 to specify options for each level or level of multi-level dock 202. For example, a user can select graphical element 310 to invoke an interface for specifying options for each level or level of multi-level dock 202. In some implementations, each level 312, 314, 316 can be configured to present particular display objects according to type or category. For example, each display object (or application or file corresponding to a display object) can have metadata that describes the display object and/or corresponding application or file. The metadata can include type or category information (e.g., application, music file, video file, etc.). In some implementations, each level can be configured to present display objects associated with a particular type or category. For example, level 312 can be configured to present application display objects. Level 314 can be configured to display movie file display objects. Each level can be configured to display pictures, movies, text documents, or any other file type.

In some implementations, a name associated with a category, classification or type specified for a particular level can be displayed on the level. For example, in the three-dimensional representation of the level, the level can have a top surface upon which the display objects appear to rest, a bottom surface, a front surface that appears closest to a user, a back surface, and right and left surfaces. The category name (e.g., “applications,” “pictures,” “movies,” etc.) can be displayed on the front surface of the level, for example. Thus, each level can be labeled according to file type.

In some implementations, if there are more display objects for a category than a single level of multi-level dock 202 can present, the level can be configured to allow scrolling through all of the display icons available on the computing device for the category represented by the level. For example, display objects that are not visible on the level can be brought into view when input is received indicating that a user wishes to scroll through the display objects associated with the category. Scrolling can be performed horizontally or vertically according to the orientation of the particular level.

Although implementations disclosed above are described with reference to a three-dimensional multi-level dock, other three-dimensional representations or metaphors can be used to present display objects for accessing applications and/or files on a computing device. For example, the three dimensional multi-level dock can appear as a three-dimensional bookcase or a three-dimensional drawer for presenting display objects.

### Example Process

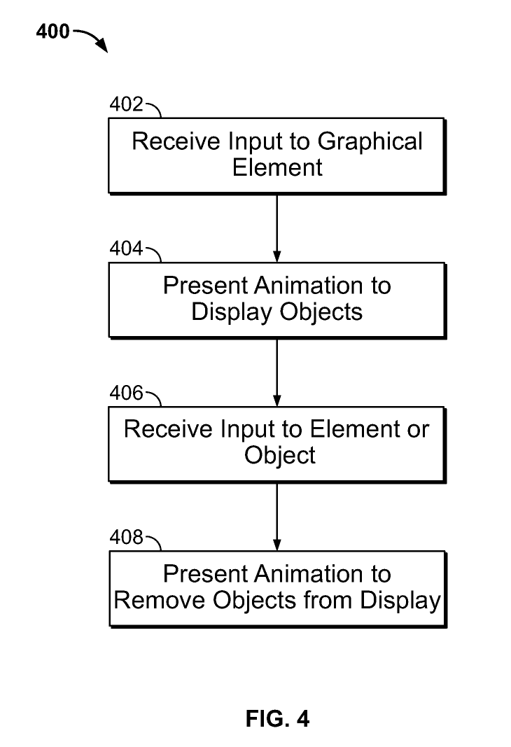

FIG. 4 is flow diagram of an example process 400 for presenting the three-dimensional animation for providing access to applications. At step 402, input to a graphical element is received. For example, a user can select graphical element 120 of FIG. 1.

At step 404, an animation is presented to display graphical objects. For example, in response to the input to graphical element 120 a three-dimensional multi-level dock animation can be displayed. In some implementations, the animation can appear to morph dock 102 into a three dimensional multi-level dock. For example, dock 102 can be expanded to appear substantially the width (or height, depending on the orientation of dock 102) of interface 100. Then, the expanded dock can appear to slide toward the middle of interface 100 while revealing a three-dimensional multi-level dock having the expanded dock as the top level of the multi-level dock. In some implementations, the three-dimensional multi-level dock can present display objects (e.g., icons) that are selectable to invoke applications or present files available to a computing device implementing the animation, as described above.

At step 406, input to a graphical element or object is received. For example, a user can select graphical element 120 or a user can select a display object presented in the three-dimensional multi-level dock.

At step 408, an animation is presented to remove the graphical objects from display. For example, in response to the selection of the graphical element or display object, the three-dimensional multi-level dock can be animated to slide from view on the display. In some implementations, the animation can appear to morph the three-dimensional multi-level dock into dock 102. For example, the multi-level dock can be animated to appear to gradually slide off or withdraw into an edge of the interface 200 until only the top level is displayed. The top level can then be contracted or shortened until the top level appears as dock 102. For example, the top level having substantially the same width or height as interface 100, can be reduced in width or height to the width or height of dock 102 before dock 102 was morphed into the three-dimensional multi-level dock.

### Example System Architecture

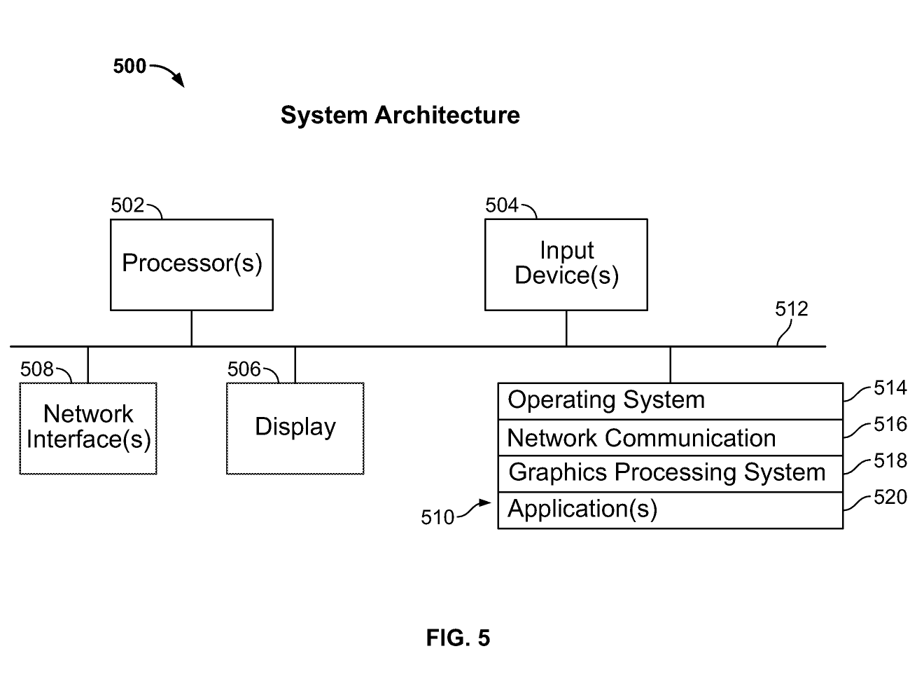

FIG. 5 is a block diagram of an example system architecture implementing the features and processes of FIGS. 1-4. The architecture 500 can be implemented on any electronic device that runs software applications derived from compiled instructions, including without limitation personal computers, servers, smart phones, media players, electronic tablets, game consoles, email devices, etc. In some implementations, the architecture 500 can include one or more processors 502, one or more input devices 504, one or more display devices 506, one or more network interfaces 508 and one or more computer-readable mediums 510. Each of these components can be coupled by bus 512.

Display device 506 can be any known display technology, including but not limited to display devices using Liquid Crystal Display (LCD) or Light Emitting Diode (LED) technology. Processor(s) 502 can use any known processor technology, including but are not limited to graphics processors and multi-core processors. Input device 504 can be any known input device technology, including but not limited to a keyboard (including a virtual keyboard), mouse, track ball, and touch-sensitive pad or display. Bus 512 can be any known internal or external bus technology, including but not limited to ISA, EISA, PCI, PCI Express, NuBus, USB, Serial ATA or FireWire. Computer-readable medium 510 can be any medium that participates in providing instructions to processor(s) 502 for execution, including without limitation, non-volatile storage media (e.g., optical disks, magnetic disks, flash drives, etc.) or volatile media (e.g., SDRAM, ROM, etc.).

Computer-readable medium 510 can include various instructions 514 for implementing an operating system (e.g., Mac OS®, Windows®, Linux). The operating system can be multi-user, multiprocessing, multitasking, multithreading, real-time and the like. The operating system performs basic tasks, including but not limited to: recognizing input from input device 504; sending output to display device 506; keeping track of files and directories on computer-readable medium 510; controlling peripheral devices (e.g., disk drives, printers, etc.) which can be controlled directly or through an I/O controller; and managing traffic on bus 512. Network communications instructions 516 can establish and maintain network connections (e.g., software for implementing communication protocols, such as TCP/IP, HTTP, Ethernet, etc.).

A graphics processing system 518 can include instructions that provide graphics and image processing capabilities. For example, the graphics processing system 518 can implement the processes described with reference to FIGS. 1-4.

Application(s) 520 can be an application that uses or implements the processes described in reference to FIGS. 1-4. The processes can also be implemented in operating system 514.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method comprising:
causing a graphical object to display on a user interface of a computing device;
receiving a selection of the graphical object;
in response to the selection, causing a three-dimensional multi-level dock having one or more levels to display on the user interface; and
causing one or more graphical objects to display on the levels of the three-dimensional multi-level dock.

2. The method of claim 1, further comprising:
animating the three-dimensional multi-level dock to slide into the user interface.

3. The method of claim 1, further comprising:
causing one or more dock graphical objects to display on the user interface before receiving the selection of the graphical object; and
causing the one or more dock graphical objects to display on a top level of the three-dimensional multi-level dock after receiving the selection of the graphical object.

4. The method of claim 1, wherein the one or more graphical objects represent one or more applications of the computing device.

5. The method of claim 1, wherein the one or more graphical objects represent one or more files accessible to the computing device.

6. The method of claim 1, wherein the one or more graphical objects are sorted alphabetically by a name associated with the icon.

7. The method of claim 1, wherein the one or more graphical objects are sorted by how often each icon is selected.

8. The method of claim 1, wherein each of the one or more levels is associated with a respective category, wherein each of the one or more graphical objects is associated with a respective category, and further comprising:
causing a particular icon to be displayed on a particular level based on the category associated with the icon and the category associated with the level.

9. The method of claim 1, further comprising:
receiving input specifying sorting criteria for the one or more graphical objects displayed on the three-dimensional multi-level dock.

10. A non-transitory computer-readable medium including one or more sequences of instructions which, when executed by one or more processors, causes:
displaying a graphical object on a user interface of a computing device;
receiving a selection of the graphical object;
in response to the selection, causing a three-dimensional multi-level dock having one or more levels to display on the user interface; and
displaying one or more graphical objects on the levels of the three-dimensional multi-level dock.

11. The non-transitory computer-readable medium of claim 10, wherein the instructions comprise instructions that cause:
animating the three-dimensional multi-level dock to slide into the user interface.

12. The non-transitory computer-readable medium of claim 10, wherein the instructions comprise instructions that cause:
displaying one or more dock graphical objects on the user interface before receiving the selection of the graphical object; and
displaying the one or more dock graphical objects on a top level of the three-dimensional multi-level dock after receiving the selection of the graphical object.

13. The non-transitory computer-readable medium of claim 10, wherein the one or more graphical objects represent one or more applications of the computing device.

14. The non-transitory computer-readable medium of claim 10, wherein the one or more graphical objects represent one or more files accessible to the computing device.

15. The non-transitory computer-readable medium of claim 10, wherein the one or more graphical objects are sorted alphabetically by a name associated with the icon.

16. The non-transitory computer-readable medium of claim 10, wherein the one or more graphical objects are sorted by how often each icon is selected.

17. The non-transitory computer-readable medium of claim 10, wherein each of the one or more levels is associated with a respective category, wherein each of the one or more graphical objects is associated with the respective category, and wherein the instructions cause:
displaying a particular icon on a particular level based on the category associated with the icon and the category associated with the level.

18. The non-transitory computer-readable medium of claim 10, wherein the instructions comprise instructions that cause:
receiving input specifying sorting criteria for the one or more graphical objects displayed on the three-dimensional multi-level dock.

19. A system comprising:
at least one processor; and
a computer-readable medium including one or more sequences of instructions which, when executed by one or more processors, causes:
displaying a graphical object on a user interface of a computing device;
receiving a selection of the graphical object;
in response to the selection, causing a three-dimensional multi-level dock having one or more levels to display on the user interface; and
displaying one or more graphical objects on the levels of the three-dimensional multi-level dock.

20. The non-transitory computer-readable medium of claim 19, wherein the instructions comprise instructions that cause:
animating the three-dimensional multi-level dock to slide into the user interface.

21. The non-transitory computer-readable medium of claim 19, wherein the instructions comprise instructions that cause:
displaying one or more dock graphical objects on the user interface before receiving the selection of the graphical object; and
displaying the one or more dock graphical objects on a top level of the three-dimensional multi-level dock after receiving the selection of the graphical object.

22. The non-transitory computer-readable medium of claim 19, wherein the one or more graphical objects represent one or more applications of the computing device.

23. The non-transitory computer-readable medium of claim 19, wherein the one or more graphical objects represent one or more files accessible to the computing device.

24. The non-transitory computer-readable medium of claim 19, wherein the one or more graphical objects are sorted alphabetically by a name associated with the icon.

25. The non-transitory computer-readable medium of claim 19, wherein the one or more graphical objects are sorted by how often each icon is selected.

26. The non-transitory computer-readable medium of claim 19, wherein each of the one or more levels is associated with a respective category, wherein each of the one or more graphical objects is associated with the respective category, and wherein the instructions cause:
displaying a particular icon on a particular level based on the category associated with the icon and the category associated with the level.

27. The non-transitory computer-readable medium of claim 19, wherein the instructions comprise instructions that cause:
receiving input specifying sorting criteria for the one or more graphical objects displayed on the three-dimensional multi-level dock.
